(19) United States
(12) Patent Application Publication
(10) Pub. No.: US 2026/0301044 A1
(43) Pub. Date: Oct. 1, 2026

(54) AUTOMATED RECOMMENDATION SYSTEM

(71) Applicant: MTN GROUP MANAGEMENT SERVICES (PROPRIETARY) LIMITED, Roodepoort, Gauteng (ZA)

(72) Inventors: Michael Geoffrey BELL, Hartbeespoort (ZA); Rizwan Haroon BHAWRA, Sandton (ZA); Kavish MAHARAJ, Sandton (ZA); Ankur BAJPAI, Lucknow (IN)

(73) Assignee: MTN GROUP MANAGEMENT SERVICES (PROPRIETARY) LIMITED, Roodepoort, Gauteng (ZA)

(21) Appl. No.: 19/100,771

(22) PCT Filed: Aug. 3, 2023
(86) PCT No.: PCT/IB2023/057876

§ 371 Date: Feb. 3, 2025

(30) Foreign Application Priority Data
Aug. 4, 2022 (IN) 202221044616

(51) Int. Cl. G06Q 30/0601; G06Q 30/0204; G06Q 30/0207

(52) U.S. Cl. CPC G06Q 30/0631; G06Q 30/0224; G06Q 30/0204

(57) ABSTRACT

There is provided for an automated recommendation system and a method carried out by such a system. The automated recommendation system is capable of automating and dynamically improving the process of determining the “next best” activity, action, offer, experience, or the like, to be recommended to/for a customer.

### FIELD OF THE INVENTION

The invention relates to an automated recommendation system. The invention also relates to methods carried out by such a system.

### BACKGROUND TO THE INVENTION

Customer value management (CVM) can be described as the process of managing and optimising the facets of a value journey that a customer takes in association with a business, from their first interaction to the last one.

When a business has a large and diverse customer base, it is generally difficult or even impossible for its marketing team to address all the various customer segments and micro-segments and to create, develop and maintain appropriate experiences and offerings for each of those micro-segmented customers.

For example, a telecommunications business may have thousands or even millions of customers (or subscribers), spanning a large number of segments. These customers can be presented with a wide variety of offers, such as offers for products and/services relating to voice, internet, data, payments, digital services, enterprise services, network solutions, combinations of these, and many more. Traditional methods of CVM typically target a limited number of segments, leaving much to be desired for the other segments or micro-segments and the value that could be generated and experiences that could be improved, e.g. by offering suitable products and/or services to customers in those other segments. It has been shown that untapped segments expose pockets of untouched opportunities (e.g. to increase revenue, customer tenure, usage, and the like).

It is therefore desirable to ascertain, for a particular customer or segment, what the “next best” action, activity, offer, or experience (i.e. the most appropriate “thing” to be offered to the customer), is likely to be, so that a recommendation can be made to the customer or to a marketing/sales team. Technology can play a role in facilitating CVM, and systems have been developed in an attempt to improve on its historically manual processes. Through the use of data engineering, prior art systems typically make use of a database with customer attributes, linked to a CVM system (or customer base management system) which is configured to analyse the customer attributes and do certain basic assessments, such as churn prediction (e.g. detecting which customers are likely to leave a service or to cancel a subscription to a service), and to provide management features for marketing campaigns.

The Applicant has found that most known systems are fairly basic and often still require significant manual intervention. Furthermore, they may have numerous technical drawbacks. For example, the CVM systems of which the Applicant is aware lack advanced analytics capabilities, multi-dimensional behavioural analysis capabilities and the ability to make real-time recommendations across large numbers of segments or micro-segments. In addition, the Applicant has found that these systems may lack automated, closed-loop feedback capabilities, i.e. the systems are not able to adapt based on successful and/or unsuccessful outcomes and significant manual adjustments are required. The Applicant further noticed that while there are a number of solutions in the market that can assist with customer segmentation, these systems typically have a technical drawback in that they are not configured to adequately consider customer lifecycle stages. As a result, the systems that are known to the Applicant do not provide satisfactory solutions, and marketing, sales and/or CVM teams are still required to drive these processes with relatively little automation.

The Applicant carried out a detailed review and research in respect of technological solutions available in the market, but was unable to find a holistic, end-to-end technology which can address its requirements. While there are tools that can address specific elements of CVM, using disparate tools from multiple vendors naturally has its disadvantages and a vendor agnostic, holistic system may well be preferable.

It is clearly desirable to address at least some of the drawbacks mentioned above through a substantially automated technological solution which can assist in targeting customers differently based on their needs, choices, and behaviour, and create a customised experience to their liking. As a result, the Applicant embarked on a project of designing and developing an enhanced recommendation system, capable of automating and dynamically improving the process of determining the “next best” activity, action, offer, experience, or the like, to be recommended to/for a customer, aspects of which are described in this specification.

### SUMMARY OF THE INVENTION

In accordance with an aspect of the invention, there is provided an automated recommendation system, the system comprising:
a data source layer which includes customer data from a plurality of data sources, the data source layer being configured such that the customer data is dynamically or periodically updated;
a processing sub-system which is communicatively coupled to the data source layer, wherein the processing sub-system is configured to process the customer data, including generating customer segment data based on at least customer behaviour data and customer lifecycle stage data obtained or derived from the data sources, wherein the processing sub-system includes or implements a recommendation engine which is configured to generate customer-specific recommendations based on a plurality of machine learning (ML) algorithms and/or heuristic models applied to the processed customer data, wherein each customer-specific recommendation is indicative of a proposed best action for a specific customer or customer segment, the proposed best action being either a next offer for a business associated with the system to make to the customer/segment or a next action for the business to take in respect of the customer/segment; and
an interface layer which is communicatively coupled to the processing sub-system to receive output indicative of the customer-specific recommendations, and which is further communicatively coupled to a plurality of user devices, thereby allowing the user devices to access the customer-specific recommendations,
wherein the processing sub-system is further configured to receive feedback data indicative of a degree or level of success associated with automated customer-specific recommendations generated by the system, the processing sub-system and recommendation engine being configured to utilise the feedback data so as to dynamically or periodically update the customer data and, as a result, the customer-specific recommendations.

The customer-specific recommendation may be a so-called “next best experience” utilised in CVM. The term “NBx” may be used, with “NB” denoting “next best” and “x” denoting offer (product or service), activity, experience, action, or the like, to be presented to the relevant customer.

In embodiments of the invention, based on ML algorithms and/or heuristic models, each customer's journey, patterns, and behaviour can be learnt by these models. These are used to make the customer-specific recommendations, e.g. to propose offers that should be extended to the customer, and for each stage of their lifecycle. Each customer may have a specific lifecycle stage associated with them. The stages may for instance be acquisition, growth, retention, and win-back.

The system may include an analytics layer and a recommendation engine vault forming part of the processing sub-system. The analytics layer may include a staging layer, an aggregated layer and an output layer. The vault may house the ML algorithms and/or heuristic models. In some embodiments, the analytics layer and/or vault may be implemented as one or more edge nodes forming part of the system.

The feedback data may include data relating to update of customer-specific recommendations and financial data relating thereto, e.g. incremental revenue.

The recommendation system may be integrated into a downstream marketing system, e.g. a campaign management system (CMS) for multi-channel marketing.

The analytics layer and/or vault may be in communication with each other and the CMS, e.g. via a data warehouse. The analytics layer may be configured to implement a feedback loop process in terms of which the customer data and/or customer-specific recommendations are continuously updated based on feedback data received from the downstream marketing system.

The interface layer may be configured to connect the recommendation system to a dashboard or user interface, e.g. for output visualisation.

In accordance with another aspect of the invention, there is provided an automated recommendation method, the method comprising:
connecting a data source layer to a processing sub-system, the data source layer including customer data from a plurality of data sources fed into the processing sub-system;
dynamically or periodically updating the customer data;
processing, by the processing sub-system, the customer data, including generating customer segment data based on at least customer behaviour data and customer lifecycle stage data obtained or derived from the data sources;
generating, by a recommendation engine forming part of or implemented by the processing sub-system, customer-specific recommendations based on a plurality of ML algorithms and/or heuristic models applied to the processed customer data, wherein each customer-specific recommendation is indicative of a proposed best action for a specific customer or customer segment, the proposed best action being either a next offer for a business to make to the customer/segment or a next action for the business to take in respect of the customer/segment;
connecting the processing sub-system to a plurality of user devices via an interface layer, the interface layer being communicatively coupled to the processing sub-system to receive output indicative of the customer-specific recommendations and communicatively coupled to the user devices thereby allowing the user devices to access the customer-specific recommendations;
receiving, by the processing sub-system, feedback data indicative of a degree or level of success associated with automated customer-specific recommendations generated by the system; and
updating the customer data and customer-specific recommendations by the processing sub-system and recommendation engine, using the feedback data.

It will be understood that the automated recommendation method is a computer-implemented method.

In accordance with another aspect of the invention, there is provided for use of the automated recommendation method to generate one or more customer-specific recommendations.

The step of generating customer-specific recommendations may include receiving, by the recommendation engine, input data from an analytics layer of the processing sub-system. The method may include performing, by the analytics layer, a feedback loop process in terms of which the customer data and/or customer-specific recommendations are continuously updated based on feedback data received from a downstream system such as a marketing/CVM system.

The customer behaviour data may include data indicative of all, or the majority of, interactions of a customer with the business across multiple product and services lines.

In accordance with another aspect of the invention, there is provided a computer program comprising instructions which, when the program is executed by a computer, cause the computer to carry out the steps of the automated recommendation method and additional steps described and included above.

In accordance with another aspect of the invention, there is provided a data processing device comprising means for carrying out the steps of the automated recommendation method and additional steps described and included above.

In accordance with another aspect of the invention, there is provided a computer-readable storage medium comprising instructions which, when executed by a computer, cause the computer to carry out the steps of the automated recommendation method and additional steps described and included above.

In accordance with another aspect of the invention, there is provided a computer-implemented method of providing a customer with an automated recommendation, comprising: receiving an input dataset comprising customer data from a data source layer; carrying out the steps of the automated recommendation method and additional steps described and included above; and producing an output dataset comprising one or more customer-specific recommendations.

In accordance with another aspect of the invention, there is provided a computer-implemented method of training a machine-learning model for computer-implemented method of, in particular the machine-learning model of the automated recommendation method described above, comprising: receiving an input dataset comprising customer data from a data source layer; and training the machine-learning model by deriving the customer's journey, patterns, and behaviour from the customer data to make customer-specific recommendations.

In some embodiments, the system may be configured to map available offers to specific customers or segments based on an analysis of the processed data through the recommendation engine. Alternatively or additionally, the system may generate a customer-specific recommendation in the form of a unique product or service offering for a specific customer or segment, based on an analysis of the processed data.

Embodiments of the invention may extend to one or more computer program product for implementing the recommendation system, the computer program product comprising at least one computer-readable storage medium having program instructions embodied therewith, the program instructions being executable by at least one computer to cause the at least one computer to carry out techniques and implement features substantially as described above. Extend shall herein include the definition of being applicable to.

The computer-readable storage medium may be a non-transitory storage medium. The computer program product may be implemented across multiple devices and locations, etc.

### BRIEF DESCRIPTION OF THE DRAWINGS

The invention will now be further described, by way of example, with reference to the accompanying drawings.

In the drawings:

FIG. 1 is a schematic illustration of an exemplary system architecture including an embodiment of a recommendation system according to the invention;

FIG. 2 is a flow diagram illustrating certain processes associated with a recommendation method according to an embodiment of the invention;

FIG. 3 is a flow diagram illustrating certain data flows and processes in an example embodiment of the invention;

FIG. 4 is also a flow diagram illustrating certain data flows and processes in an example embodiment of the invention;

FIG. 5 is an exemplary diagrammatical framework of a customer evaluation process which may be used in an example embodiment of the invention;

FIG. 6 is a diagram illustrating, from a functional perspective, where a recommendation engine according to embodiments of the invention may fit in to a larger system architecture;

FIG. 7 is an exemplary table illustrating the manner in which customer-specific recommendations can be used to increase customer engagement and revenue potential;

FIG. 8 is a set of illustrative screenshots showing an exemplary web application user interface flow allowing for user intervention;

FIG. 9 is a diagrammatical illustration of a composition of a ML-heuristics vault and how it may be applied to different customer lifecycle stages to generate recommendations in an automated manner; and

FIG. 10 is a block diagram of an exemplary computer system capable of executing a computer program product to provide functions and/or actions according to various aspects of the invention.

### DETAILED DESCRIPTION WITH REFERENCE TO THE FIGURES

The following description is provided as an enabling teaching of the invention, is illustrative of principles associated with the invention and is not intended to limit the scope of the invention. Changes may be made to the embodiment/s depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

Embodiments of the invention provide an enhanced technological solution to facilitate CVM from the acquisition stage of a customer lifecycle, through to their full potential (mature customer) to inculcate loyalty and provide the best possible experience, while driving business value and reducing churn. Embodiments of the invention may provide technical solutions to one or more of the technical drawbacks with current systems.

Unlike traditional approaches, NBx may work by segmenting customers based on their behaviour, stage in life, cross-product, social circuit influence, and other elements.

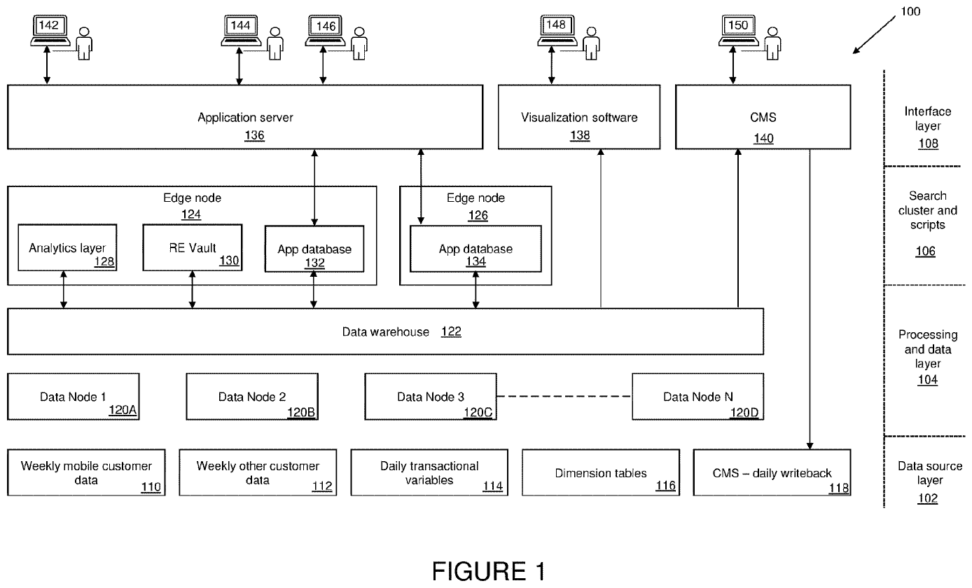

Referring to FIG. 1, an example embodiment of the automated recommendation system 100 may include a data source layer 102, a processing and data layer 104, a search cluster and script layer 106 and an interface layer 108. The layers 104 and 106 may constitute a processing sub-system of the recommendation system 100.

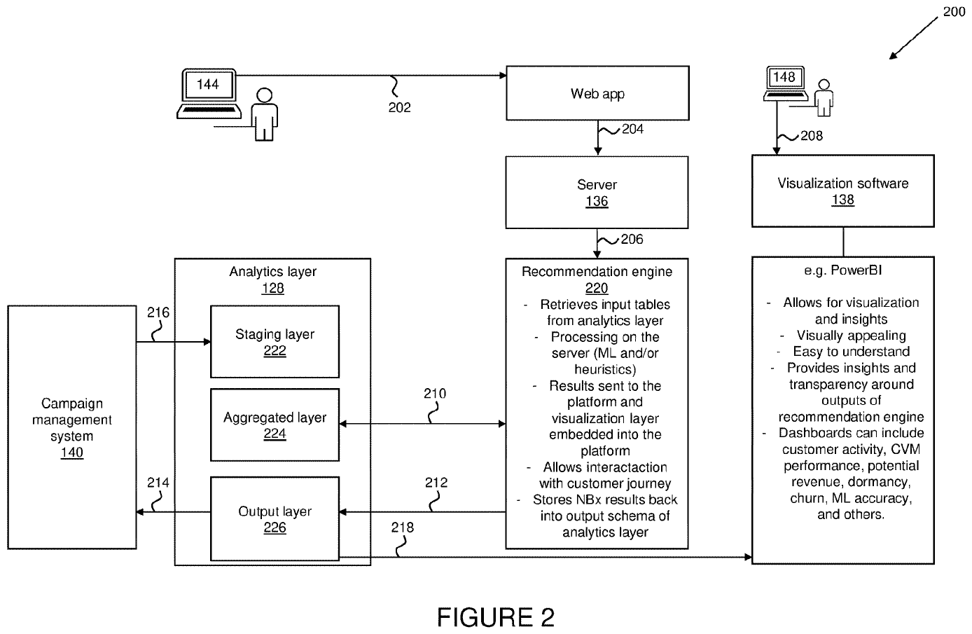

The data source layer 102 has a plurality of sources of customer data. In the example embodiment of FIGS. 1 and 2 (and as may be apparent from some of the other figures), the business is a telecommunications business that provides mobile and other products and services. The data sources may thus for instance include weekly mobile customer data 110, weekly other (e.g. financial or payment app) data 112, daily transactional variables 114, dimension tables 116 and daily writeback data (inbound and outbound) 118 from a campaign management system 140. These data sources are updated, either dynamically (in real-time) or periodically.

The system's processing and data layer 104 includes a plurality of data notes 1−N (marked 120A, 120B, 120C and 120D in FIG. 1) and a data warehouse 122 is provided to receive and house the aforementioned data. The data warehouse 122 is a repository for an analytics layer data mart (see below), recommendation model output and search inputs associated with app databases (see below).

Edge notes 124, 126 are provided, which store and implement an analytics layer 128, a recommendation engine vault 130, and app databases 132, 134. The analytics layer 128 may include or run data mart scripts. The vault 130 houses the ML models and heuristics required to implement the recommendation engine/model as will be described further below. The vault may be referred to as an ML-heuristics vault. The app databases 132, 134 may permit searching e.g. through Elasticsearch™.

Turning to the interface layer 108, an application server 136 is connected to the edge nodes 124, 126 via a suitable API, allowing an administrator device 142 and user devices 144, 146 to access various aspects of the system as will be described further below. This may allow an administrator and/or users to make changes or adjustments via a web application. The system 100 further includes visualization software 138 (e.g. PowerBI™) allowing a user device 148 to do results visualizations and the like from the data warehouse 122. The CMS 140 can be accessed by a CMS user device 150.

The system 100 provides an integrated, end-to-end platform, connecting source data systems and downstream CVM systems like the CMS (140) in a multi-channel approach.

Based on ML algorithms and heuristic models in the vault 130, each customer's (and/or each segment's) journey, patterns, and behaviour may be learnt by the system 100. These are used to propose the NBx, i.e. the next best offer/activity, that should be extended to the customer, taking into account each stage of their lifecycle acquisition, growth, retention, and win-back. The system 100 is configured to do this automatically without human intervention (or with minimal intervention as may be required in the implementation). The NBx outcome/result per customer (e.g., a product offering) is integrated with the downstream systems like the CMS 140.

The recommendation engine may be configured to consider specific KPIs or goals and to recommend offers which are likely to maximise or achieve them. For example, the recommendation engine may consider what do to increase penetration into certain segments, to increase the overall number of users, to increase revenue, or combinations of these. The recommendation engine may enable the ranking of top offers, e.g. top offers by potential revenue and profitability (which may be a function of uptake propensity and time).

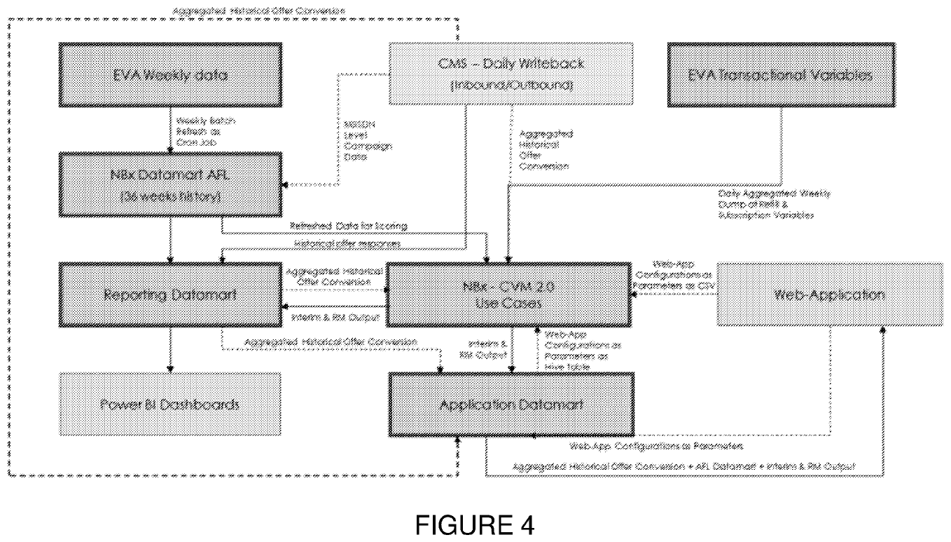

Through the analytics layer 128, which may be referred to as an “analytics foundation layer” (referred to as “AFL”, see for instance FIG. 4), orchestration for an end state of an event-driven ecosystem may be provided. The vault 130 allows for the recommendation engine/model to be implemented based on cutting edge, advanced analytics solutions. The interface layer 108 provides for rich visualization (e.g. key performance indicator visualization or customer segment insights). These elements thus combine to provide a decision-support tool.

A number of visualizations may be enabled. For instance, an output summary of the recommendations aggregated by lifecycle stage, behavioural segment, revenue segment, value band, region, NBx (e.g. next best action or activity or offer), may be presented, and these may be ranked. The interface layer 108 may enable users to carry out simulations on different NBx combinations (e.g. “next best action” and “next best offer” combinations), and evaluate the impact on incremental revenue. A detailed view of profiles of the customers and segments may be provided, enabling a business to compare the segments and movement overtime.

Users may provide input into the system 100, for example by creating activities/offers to be considered, which activities to be evaluated or prioritized, filter recommendations, etc.

In embodiments of the invention, a next best action may be determined using a plurality of machine learning models and/or heuristics, across different product/service lines. For the business in the example embodiment of the invention, this may for instance be across, data, voice, SMS, value added services (VAS), fintech and digital channels.

From a ML perspective, the recommendation engine may apply classification techniques (binomial and/or multinomial, e.g. logistic regression, random forest, gradient boosting, XG boost etc.), clustering (e.g. K-means, kNN), forecasting (e.g. ARIMA) and validation metrics (e.g. Recall, Precision, FScore, etc.). Multiple heuristics may be programmed into the engine, such as business rules for the right intervention at the right time with the right prioritization, identification of subscriber activity, segment movement, subscriber cannibalization, customer exodus, product and channel preferences. The recommendation engine may be designed to select a best offer from an offer library and/or to create new offers. The recommendation engine is, in this example embodiment, configured such that it is able to create completely unique offers to customers. This is described further below.

Offers that are ultimately recommended for customers/segments may be categorized by activities and service lines, using the recommendation engine to identify the best “thing” to offer for a particular customer or to a customer segment (customer-specific recommendations).

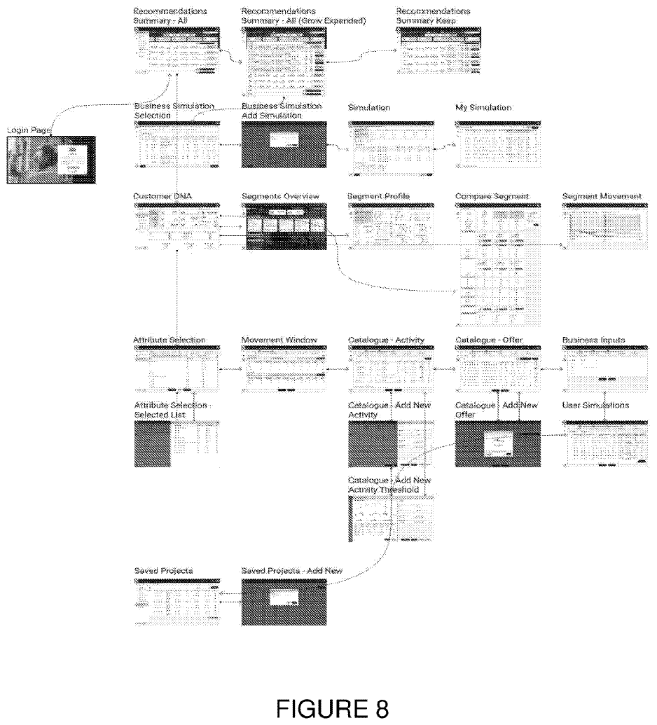

Referring to FIG. 2, a user 144 can access the web application (stage 202) which connects to a server (stage 204) and in turn to the results of the recommendation engine 220 (stage 206). A suitable web application may be visually interactive, summarizing customer-specific or segment-specific recommendations, and may enable a user to run simulations on certain inputs and evaluate the impact of certain changes. An administrator may also provide or change recommendation model settings via the web application, e.g. to provide settings for a next scheduled batch intended to generate a new set of customer-specific recommendations. The web application (or another application or channel used to access the server 136) thus allows for a degree of business intervention, e.g. on existing or new service and eligibility rules, ranking specific NBx's, modification of offer catalogues, etc. The inclusion of the web application or another similar tool may make the entire framework a type of “man-machine model”, allowing the business to intervene and control at least certain basic strategic priorities. FIG. 8 shows some examples of screens that a user of the web application can utilise in an embodiment of the invention. The “Business Simulation Selection” screen provides an important example of a user interface which allows a user to do scenario planning. This is achieved by a master user (or a user with the necessary permission to access and operate the user interface) amending or making alterations to the input parameters and/or model settings of the recommendation system, such that the ML algorithms and/or heuristic models generate a new set of customer-specific recommendations, which are then approved before sending them to the campaign management system 140. This provides a manual element whereby the master use is capable of approving an offer catalogue of customer-specific recommendations generated through manual intervention. Furthermore, these manual changes generation of a new set of customer-specific recommendations can be for one or more customers.

The creation by the system 100 of micro-segments (based on customer behaviour data and lifecycle stage date, and others, depending on the embodiment) may assist users in defining the relevant programs and activities, and eventually control the recommendations by intervening on service and activity catalogues. The NBx recommendation model implemented by the engine 220 may be configured to evaluate all interactions of customers with the business (or a large proportion of them), across different service and product lines, and will provide recommendations for the NBx.

Referring to stages 210, 212, 214 and 216 in FIG. 2, a feedback loop process is implemented in terms of which customer data and/or customer-specific recommendations are updated based on feedback data received from the CMS 140.

The CMS provides feedback data to a staging layer 222 of the analytics layer 128. The analytics layer serves as the cornerstone for the recommendation engine 220 and has an aggregated layer 224 which processes and combines multiple customer data sets for analysis by the recommendation engine. The recommendation engine 220 provides its output, e.g. in the form of customer-specific recommendations or segment-specific recommendations (NBx's), and these are provided to an output layer 226 of the analytics layer 128 which in turn feeds the output to the CMS (see stage 214). The recommendations may for instance be recommend NBA (next best activity) and NBO (next best offer) data across lifecycle stages, segments, and lines of business. The recommendation engine 220 can, for a particular customer or segment, generate a unique offering that has never been sold by the business before, e.g. “the recommendation is to offer product A to segment B, which includes 3GB of monthly data and 55 monthly voice minutes, and the best channel to offer through is via e-mail”, as being the offer most likely to be successful.

In other words, the output from the output layer at stage 214 is used for marketing/sales campaign execution. At stage 216, the CMS 140 provides feedback data back to the staging layer 222 so that the system 100 can auto-adjust and “self-heal” based on the success of the NBx's recommended.

In this way, the system 100 allows for closed-loop feedback about the reception of the solution-generated NBx and auto-tuning, self-healing models. This may facilitate achieving per customer, or virtually per customer, product (or experience) differentiation into the very many multitudes of micro-segments, at near real-time or event triggered pace.

The result of the campaigns are analysed automatically by the processing sub-system, e.g. uptake, incremental revenue, to adjust the relevant models and algorithms for improvement of recommendations.

The outputs received from the recommendation engine can be sent from the output layer 226 to visualization software 138. A user device 148 can then access the software 138.

NBx outcomes can be used by a CVM team directly, but also by fully integrated downstream systems like FlyTxt™ or other campaign management systems for campaign execution. Embodiments of the invention thus separate analytics from a campaign tool/system (CMS) and houses the analytics in a separate data warehouse, e.g. the warehouse 122, as single point of analytics. An advantage of this approach is that it makes the recommendation system 100 downstream system agnostic.

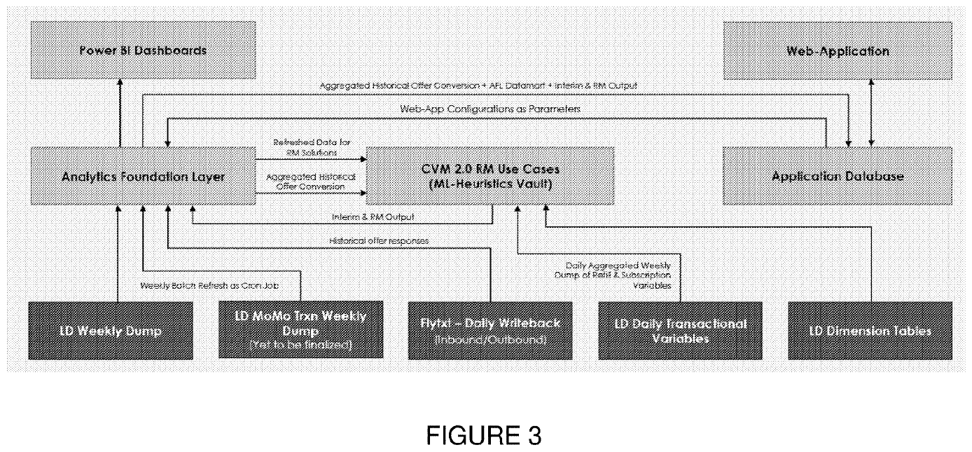

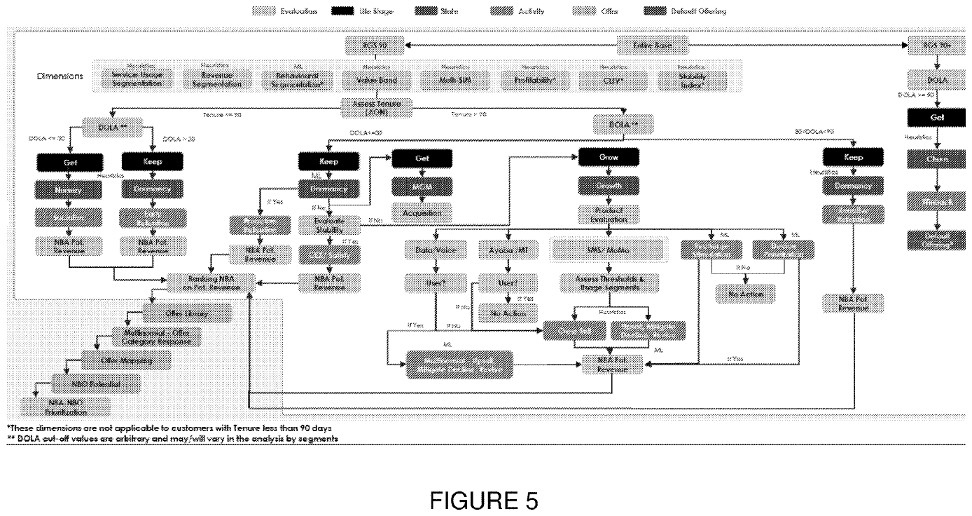

FIGS. 3 and 4 illustrate further exemplary data flows in an example where the business is a telecommunications company that also offers financial products and digital services. In FIG. 4, “MoMo” refers to a mobile money division of the business and the recommendation engine is referred to as “CVM 2.0 RM”. FIG. 5 is an exemplary diagrammatical framework of a customer evaluation process which may be used in an example embodiment of the invention.

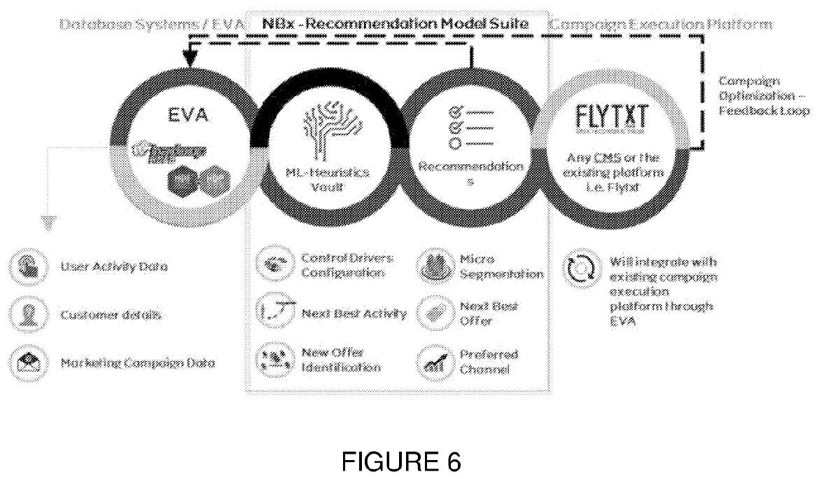

FIG. 6 provides a more high level overview of where a recommendation engine may fit into a system architecture. The term “EVA” refers to the internal data warehouse/s of the business which holds customer activity data, customer details and marketing campaign data. The ML-heuristics vault is then used to analyse these data sets and provide customer-specific recommendations as explained above. These can then be integrated into any CMS, e.g. FlyTxt™.

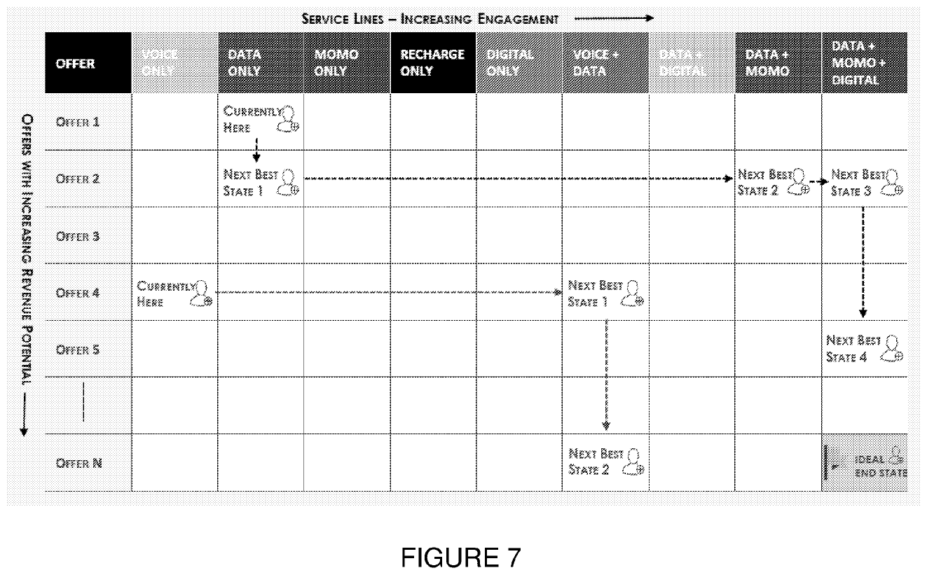

FIG. 7 again uses the example of the telecommunications business to illustrate how customers can strategically be presented with offers across different product/service lines. The following “movement principles” are notable when considering FIG. 7:
For “upsell”: movement towards the right can be evaluated to increase the “share of wallet”
For “x-sell”: movement towards the right can be evaluated for engaging on multiple lines
For “mitigate, decline and revive”: customers should stay in the grid where they currently are, but within that grid possible offers can be evaluated for increasing revenue
For “retain and satisfy on network”: movement across the grid is not advisable; the customer should stay where they are, but with more engaged offerings
For “acquire and socialise”: movement across the grid can be evaluated based on marketing campaigns

The system 100 enables mapping of offers to customers or segments based on behaviour identified, and adapting or adjusting such offers (recommendations) automatically. This allows different recommendations to be generated, e.g. in terms of a week-on-week cycle, including based on customers' reception to received NBx's and the like. This is achieved through the closed-loop feedback explained above, in terms of which the outcomes of the recommendation engine are fed back to the solution to iterate the whole process of the behavioural segmentation per customer and come up with new NBx offerings.

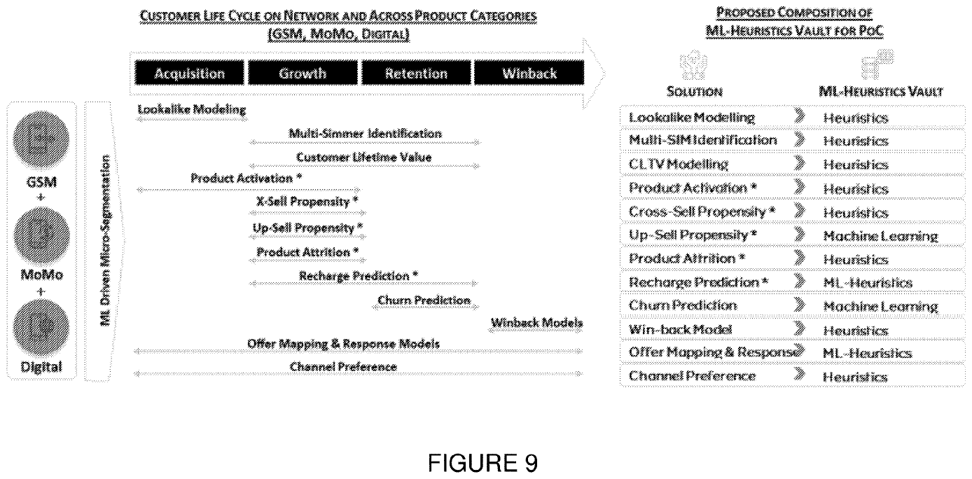

It is envisaged that, as the ML models “mature”, intelligence and effectiveness of the system 100 may increase. While an initial version of such a system may tend more towards heuristics, ML models may increase in number over time. In some embodiments each recommendation generated by the recommendation engine may be run through a ML model (or multiple models). FIG. 9 shows an example of the types of solutions that may be employed for different lifecycle stages (this is merely an illustrative example).

The system may also be configured to capitalize on, or react to, triggers/events exhibited by customers substantially in real-time. For example, the engine 220 may be programmed based on longer-term customer usage and purchase behaviour while real-time triggers from the business can also be used to present offers in real-time.

Embodiments of the invention may provide numerous advantages. Running campaigns based on results of such an automated system, utilising behavioural extremes micro-segments, may alleviate the Penrose effect which would have constrained the rate of CVM (customer value or experience) activities due to the physical number and limitations of human resources. Nonetheless, the marketing CVM managers or specialists could still do their usual tasks and campaigns, albeit with such an automated system they could focus more on strategy and overall customer value.

Moreover, embodiments of the invention may still include intervention points in the solution design whereby the marketing resource can tweak certain parameters, add thresholds, increase or decrease selection deciles (for example), and add temporary-short-lived default campaigns based on their understanding of the business and/or organisational strategic changes or emerging demographic situations.

However, embodiments of the invention may function fully without any human intervention, as the system may be an end-to-end, self-learning (closed-loop feedback) and self-healing (based on a suite of models and use cases) configuration that adapts very quickly to the changes in customer, economic or demographic dynamics, and accordingly adjusts the NBx over time. All these actions, activities, and their effect on the customer base, suggestions etc., may be communicated to a human audience (e.g., marketing teams) as dashboards and reports.

In addition, the following advantages may be achieved:
The system may provide automated recommendations with specific business priorities and strategic objectives.
The system may enable hyper-personalization by bringing together frameworks and intelligence to track patterns of customer behaviour across different touchpoints with a business.
The recommendation engine may automatically recommend the most appropriate intervention at the right time.
The system may drives long term and sustainable revenue growth.
The system may encompass all lines of a business.
While being substantially automated, the system may still enable business intervention, e.g. through a web application, to set up the environment for recommendation model running and alignment.
The system may evaluate responsiveness against different applicable offer categories and optimally map the most relevant offer to each customer with respect to their behavioural attributes and journey with the business, while taking into account affordability and applicability.
The system may incorporate or be coupled with rich KPI and sophisticated dashboards that provide an “inside view” of the recommendation engine and enable the business to make informed decisions.
The techniques described herein may have a range of use cases, spanning based on cutting edge ML techniques and heuristics, with easy and flexible additions/modifications of more use cases, as required.
The system may provide dynamic, automated and seamless execution capabilities through a robust yet flexible execution environment.
The system may provide both forward and backward integration with CMS for picking recommendations and executing based thereon, and ultimately learning based on campaign effectiveness and customers' responses, to recalibrate the offer mappings.

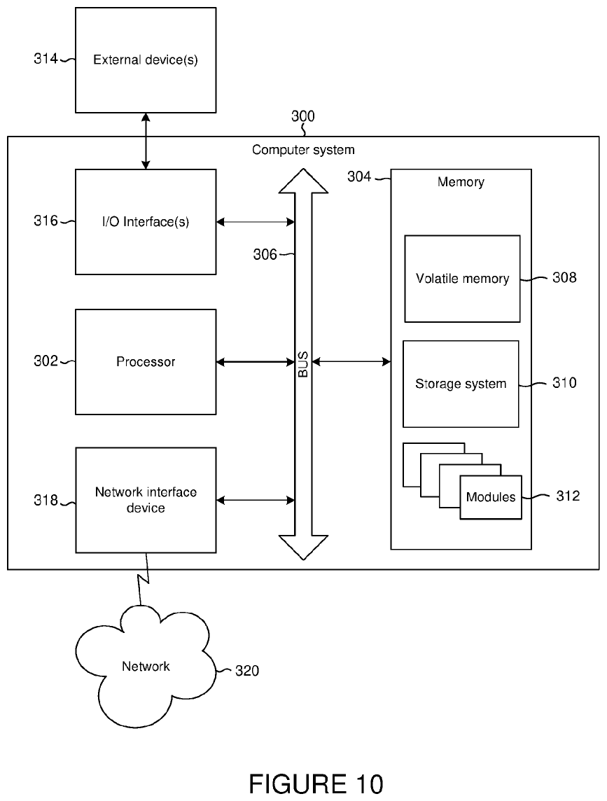

One or more techniques described above may be implemented in or using one or more computer systems, such as the computer system 300 shown in FIG. 10. The computer system 300 may be or include any suitable computer or server. The computer system 300 may be implemented in distributed cloud computing environments where tasks are performed by remote processing devices that are linked through a communications network. In a distributed cloud computing environment, program modules executed by the computer system 300 may be located both locally and remotely.

In the example shown in FIG. 10, the computer system 300 has features of a general-purpose computer. These components may include, but are not limited to, at least one processor 302, a memory 304 and a bus 306 that couples various components of the system 00 including the memory 304 to the processor 302. The bus 306 may have any suitable type of bus structure. The computer system 300 may include one or more different types of readable media, such as removable and non-removable media and volatile and non-volatile media.

The memory 304 may thus include volatile memory 308 (e.g. random access memory (RAM) and/or cache memory) and may further include other storage media such as a storage system 310 configured for reading from and writing to a non-removable, non-volatile media such as a hard drive. It will be understood that the computer system 300 may also include or be coupled to a magnetic disk drive and/or an optical disk drive (not shown) for reading from or writing to suitable non-volatile media. These may be connected to the bus 306 by one or more data media interfaces.

The memory 304 may be configured to store program modules 312. The modules 312 may include, for instance, an operating system, one or more application programs, other program modules, and program data, each of which may include an implementation of a networking environment. The components of the computer system 300 may be implemented as modules 312 which generally carry out functions and/or methodologies of embodiments of the invention as described herein. It will be appreciated that embodiments of the invention may include or be implemented by a plurality of the computer systems 300, which may be communicatively coupled to each other.

The computer system 300 may operatively be communicatively coupled to at least one external device 314. For instance, the computer system 300 may communicate with external devices 314 in the form of a modem, keyboard and display. These communications may be effected via suitable Input/Output (I/O) interfaces 316.

The computer system 300 may also be configured to communicate with at least one network 320 (e.g. the Internet or a local area network) via a network interface device 18/network adapter. The network interface device 318 may communicate with the other elements of the computer system 310, as described above, via the bus 306.

The components shown in and described with reference to FIG. 10 are examples only and it will be understood that other components may be used as alternatives to or in conjunction with those shown.

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions. Instructions may be provided to a processor of any suitable computer or other apparatus such that the instructions, which may execute via the processor of the computer or other apparatus, establish or generate means for implementing the functions or actions identified in the figures.

Finally, the Applicant is capable of submitting any training data, further data, and documentation in support of this application upon request.

1. An automated recommendation system comprising:
a data source layer which includes customer data from a plurality of data sources, the data source layer being configured such that the customer data is dynamically or periodically updated;
a processing sub-system which is communicatively coupled to the data source layer, wherein the processing sub-system is configured to process the customer data, including generating customer segment data based on at least customer behaviour data and customer lifecycle stage data obtained or derived from the data sources, wherein the processing sub-system includes or implements a recommendation engine which is configured to generate customer-specific recommendations based on a plurality of machine learning (ML) algorithms or heuristic models, or ML algorithms and heuristic models in combination applied to the processed customer data, wherein each customer-specific recommendation is indicative of a proposed best action for a specific customer or customer segment, the proposed best action being either a next offer for a business associated with the system to make to the specific customer or customer segment or a next action for the business to take in respect of the specific customer or customer segment; and
an interface layer which is communicatively coupled to the processing sub-system to receive output indicative of the customer-specific recommendations, and which is further communicatively coupled to a plurality of user devices, thereby allowing the user devices to access the customer-specific recommendations,
wherein the processing sub-system is further configured to receive feedback data indicative of a degree or level of success associated with automated customer-specific recommendations generated by the system, the processing sub-system and recommendation engine being configured to utilise the feedback data so as to dynamically or periodically update the customer data and, as a result, the customer-specific recommendations.

2. The automated recommendation system according to claim 1, wherein the ML algorithms or heuristic models, or ML algorithms and heuristic models in combination are capable of learning each customer's journey, patterns, and behaviour to make the customer-specific recommendations.

3. The automated recommendation system according to claim 2, wherein the customer-specific recommendation includes one or more offers that are made available to each customer over a specific lifecycle stage associated with each customer.

4. The automated recommendation system according to claim 3, wherein the specific lifecycle stage is selected from the group consisting of acquisition, growth, retention, win-back, and combinations thereof.

5. The automated recommendation system according to claim 1 further including an analytics layer and a recommendation engine vault forming part of the processing sub-system.

6. The automated recommendation system according to claim 5, wherein the analytics layer or the vault, or the analytics layer and the vault in combination are implemented as one or more edge nodes.

7. The automated recommendation system according to claim 5, wherein the analytics layer further includes a staging layer, an aggregated layer, and an output layer.

8. The automated recommendation system according to claim 5, wherein the vault houses the ML algorithms or heuristic models, or ML algorithms and heuristic models in combination.

9. The automated recommendation system according to claim 1, wherein the feedback data includes data relating to update of customer-specific recommendations and financial data relating thereto.

10. (canceled)

11. The automated recommendation system according to claim 5, wherein the analytics layer or the vault, or the analytics layer and the vault in combination are in communication with each other and a downstream marketing system via a data warehouse.

12. The automated recommendation system according to claim 11, wherein the analytics layer is configured to implement a feedback loop process in terms of which the customer data or customer-specific recommendations, or the customer data and customer-specific recommendations in combination are continuously updated based on feedback data received from the downstream marketing system.

13. The automated recommendation system according to claim 1, wherein the interface layer is configured to allow for a connection to a user interface which allows modification of the customer data to generate a modified customer-specific recommendation for one or more customers.

14. (canceled)

15. The automated recommendation system according to claim 1 configured to map available offers to specific customers or segments based on an analysis of the processed data through the recommendation engine.

16. The automated recommendation system according to claim 1 configured to generate a customer-specific recommendation in the form of a unique product or service offering for a specific customer or segment, based on an analysis of the processed data.

17. The automated recommendation system according to claim 1 extending to one or more computer program products for implementation thereof, wherein the computer program product includes at least one non-transitory computer-readable storage medium having program instructions embodied therewith, the program instructions being executable by at least one computer.

18. (canceled)

19. An automated recommendation method, the method comprising the steps of:
connecting a data source layer to a processing sub-system, the data source layer including customer data from a plurality of data sources fed into the processing sub-system;
dynamically or periodically updating the customer data;
processing, by the processing sub-system, the customer data, including generating customer segment data based on at least customer behaviour data and customer lifecycle stage data obtained or derived from the data sources;
generating, by a recommendation engine forming part of or implemented by the processing sub-system, customer-specific recommendations based on a plurality of ML algorithms or heuristic models, or ML algorithms and heuristic models in combination applied to the processed customer data, wherein each customer-specific recommendation is indicative of a proposed best action for a specific customer or customer segment, the proposed best action being either a next offer for a business to make to the specific customer or customer segment, or a next action for the business to take in respect of the specific customer or customer segment;
connecting the processing sub-system to a plurality of user devices via an interface layer, the interface layer being communicatively coupled to the processing sub-system to receive output indicative of the customer-specific recommendations and communicatively coupled to the user devices thereby allowing the user devices to access the customer-specific recommendations;
receiving, by the processing sub-system, feedback data indicative of a degree or level of success associated with automated customer-specific recommendations generated by the system; and
updating the customer data and customer-specific recommendations by the processing sub-system and recommendation engine, using the feedback data.

20. The automated recommendation method according to claim 19, wherein the step of generating customer-specific recommendations includes receiving, by the recommendation engine, input data from an analytics layer of the processing sub-system.

21. The automated recommendation method according to claim 19 further including the step of the analytics layer performing a feedback loop process in terms of which the customer data or customer-specific recommendations, or customer data or customer-specific recommendations in combination are continuously updated based on feedback data received from a downstream marketing system.

22. The automated recommendation method according to claim 21, wherein the customer behaviour data includes data indicative of all, or the majority of, interactions of a customer with the business across a plurality of products and services lines.

23. (canceled)

24. (canceled)

25. (canceled)

26. A computer-implemented method of providing a customer with an automated recommendation, comprising: receiving an input dataset comprising customer data from a data source layer; carrying out the steps of the method according to claim 19; and producing an output dataset comprising one or more customer-specific recommendations.

27. (canceled)
